(19) United States
(12) Patent Application Publication
(10) Pub. No.: US 2017/0283285 A1
(43) Pub. Date: Oct. 5, 2017

(54) NATURAL WATER TREATMENT CONTROL APPARATUS, NATURAL WATER TREATMENT SYSTEM, NATURAL WATER TREATMENT CONTROL METHOD, AND PROGRAM

(71) Applicant: MITSUBISHI HEAVY INDUSTRIES, LTD., Tokyo (JP)

(72) Inventors: Masayuki Tabata, Tokyo (JP); Gaku Kondo, Tokyo (JP); Katsunori Matsui, Tokyo (JP); Takayoshi Hori, Tokyo (JP); Katsuhiko Yokohama, Tokyo (JP); Yoshiaki Ito, Tokyo (JP); Shintaro Taura, Tokyo (JP); Kazuhisa Takeuchi, Tokyo (JP)

(73) Assignee: MITSUBISHI HEAVY INDUSTRIES, LTD., Tokyo (JP)

(21) Appl. No.: 15/518,102

(22) PCT Filed: Oct. 15, 2014
(86) PCT No.: PCT/JP2014/077416

§ 371 Date: Apr. 10, 2017

(51) Int. Cl. C02F 1/52; H04L 29/06; C02F 1/26

(52) U.S. Cl. CPC C02F 1/52; C02F 1/265; H04L 69/22; C02F 1/00

(57) ABSTRACT

A natural water treatment control apparatus (190) controls a treatment device configured to perform treatment used to contribute to purification of drawn natural water. The natural water treatment control apparatus (190) includes: a tide information acquiring unit (191) configured to acquire tide information serving as information associated with tides of a body of water from which the natural water is drawn; and a treatment mode determining unit (193) configured to determine a treatment mode of the treatment device on the basis of the tide information.

### TECHNICAL FIELD

The present invention relates to a natural water treatment control apparatus, a natural water treatment system, a natural water treatment control method, and a program.

### BACKGROUND ART

In seawater desalination plants which manufacture freshwater from seawater, apparatuses using a reverse osmotic membrane are well known. Performance of a reverse osmotic membrane deteriorates due to accumulation of contaminants in seawater. Thus, a pre-treatment device such as a sand filtering device or a pressurized floating device is provided at a stage previous to that of the reverse osmotic membrane. In order to secure filtration performance using the pre-treatment device, the pre-treatment device needs to be controlled in accordance with an amount of contaminants in seawater. For example, in a sand filtering device and a pressurized floating device, an amount of flocculant needs to be controlled in accordance with an amount of contaminants in seawater to remove contaminants aggregated due to addition of the flocculant. Furthermore, in a sand filtering device, contaminants accumulate in a surface of a filter layer so that the filtration performance thereof deteriorates. Thus, a frequency of backwash needs to be controlled in accordance with an amount of contaminants in seawater.

In seawater desalination plants, a treatment device configured to perform treatment used to contribute to purification of seawater using a pre-treatment device such as a backwash device or a flocculant adding device may be provided. A backwash device performs a backwash process for a sand filtering device regularly and in an emergency such as when a differential pressure of the pre-treatment device exceeds a threshold value. A flocculant adding device controls an amount of flocculant to be added in accordance with an amount of contaminants in seawater. The treatment device is controlled in accordance with results of measuring the water quality of seawater or treated water filtered through the pre-treatment device.

Note that Patent Literature 1 and 2 disclose technology for eliminating a bias in an oxygen concentration in seawater using a change in tide level in a purification device configured to purify seawater using microorganisms present in the seawater.

Also, Patent Literature 3 discloses technology for calculating tides.

### CITATION LIST

### Patent Literature

### [Patent Literature 1]

Japanese Unexamined Patent Application, First Publication No. H6-296982

### [Patent Literature 2]

Japanese Unexamined Patent Application, First Publication No. H11-342397

### [Patent Literature 3]

Japanese Unexamined Patent Application, First Publication No. S60-250286

### SUMMARY OF INVENTION

### Technical Problem

When a treatment device performs treatment used to contribute to purification of seawater on the basis of results of measuring water quality, a time lag occurs before an actual change in water quality appears in measurement results. For this reason, when the water quality of seawater rapidly changes in a short time, the execution of treatment used to contribute to purification of seawater is likely to be delayed. For example, since a frequency of backwash control using a backwash device is low, when contamination of a pre-treatment device progresses, a frequency of performing urgent backwash is likely to increase. Note that, if a frequency of urgent backwash increases, an amount of filtered water becomes insufficient, and thus, an operation rate of the entire seawater desalination plant decreases. Furthermore, for example, since an amount of addition of a flocculant using a flocculant adding device is small, filtration using the pre-treatment device is likely to become insufficient.

Accordingly, the present invention provides a natural water treatment control apparatus, a natural water treatment system, a natural water treatment control method, and a program which can appropriately perform treatment used to contribute to purification of seawater even if the water quality of drawn natural water rapidly changes in a short amount of time.

### Solution to Problem

A first aspect of the present invention is a natural water treatment control apparatus which controls a treatment device configured to perform treatment used to contribute to purification of drawn natural water, the natural water treatment control apparatus including: a tide information acquiring unit configured to acquire tide information serving as information associated with tides of a body of water from which the natural water is drawn; and a treatment mode determining unit configured to determine a treatment mode of the treatment device on the basis of the tide information.

In the first aspect, a second aspect of the present invention is a natural water treatment control apparatus in which the treatment device is a backwash device of a filtering device configured to filter the drawn natural water, and the treatment mode determining unit determines at least one of a frequency and an amount of water for backwash of the filtering device using the treatment device on the basis of the tide information.

In the first or second aspect, a third aspect of the present invention is a natural water treatment control apparatus in which the treatment device is a flocculant adding device configured to add a flocculant to the drawn natural water, and the treatment mode determining unit determines at least one of an amount of addition and a type of the flocculant of the treatment device on the basis of the tide information.

In any one of the first to third aspects, a fourth aspect of the present invention is a natural water treatment control apparatus in which the tide information includes a tide level of a natural water drawing source, and the treatment mode determining unit determines a treatment mode of the treatment device on the basis of a difference between an average value of tide levels at the time of high tide and at the time of low tide of the water drawing source and tide levels indicated by the tide information.

In any one of the first to fourth aspects, a fifth aspect of the present invention is a natural water treatment control apparatus in which the tide information includes information indicating a positional relationship between the sun and the moon.

In any one of the first to fifth aspects, a sixth aspect of the present invention is a natural water treatment system including: a treatment device configured to perform treatment used to contribute to purification of drawn natural water; and a natural water treatment control apparatus.

A seventh aspect of the present invention is a natural water treatment control method for controlling a treatment device configured to perform treatment used to contribute to purification of drawn natural water, the natural water treatment control method including: a step of acquiring tide information serving as information associated with tides of a body of water from which the natural water is drawn; and a step of determining a treatment mode of the treatment device on the basis of the tide information.

An eighth aspect of the present invention is a program causing a computer to function as: a tide information acquiring unit configured to acquire tide information serving as information associated with tides of a body of water from which natural water is drawn; and a treatment mode determining unit configured to determine a treatment mode of a treatment device configured to perform treatment used to contribute to purification of the drawn natural water on the basis of the tide information.

### Advantageous Effects of Invention

The inventors found the fact that there is correlation between an amount of contaminants in natural water and tides of a body of water. According to at least one aspect among the above-described aspects, a natural water treatment control apparatus determines a treatment mode of a treatment device on the basis of information associated with tides of a body of water from which natural water is drawn. Thus, the natural water treatment control apparatus can operate the treatment device in a treatment mode according to an amount of contaminants in the natural water.

### BRIEF DESCRIPTION OF DRAWINGS

FIG. 1 is a schematic diagram showing a constitution of a seawater treatment system related to a first embodiment.

FIG. 2 is a schematic block diagram showing a software constitution of a seawater treatment control device related to the first embodiment.

FIG. 3 is a view illustrating an example of a relationship between tide levels of a body of water to be drawn from and treatment modes of a flocculant adding device.

FIG. 4 is a view illustrating an example of a relationship between tide levels of a body of water to be drawn from and treatment modes of a backwash pump.

FIG. 5 is a flowchart for describing an operation of a seawater treatment control device related to the first embodiment.

FIG. 6 is a schematic diagram showing a constitution of a seawater treatment system related to a second embodiment.

FIG. 7 is a view illustrating an example of a relationship between types of tides of a body of water to be drawn from and treatment modes of a flocculant adding device.

FIG. 8 is a view illustrating an example of a relationship between types of tides of a body of water to be drawn from and treatment modes of a backwash pump.

FIG. 9 is a schematic block diagram showing a constitution of a computer related to at least one embodiment.

### DESCRIPTION OF EMBODIMENTS

Hereinafter, embodiments will be described in detail with reference to the drawings.

### First Embodiment

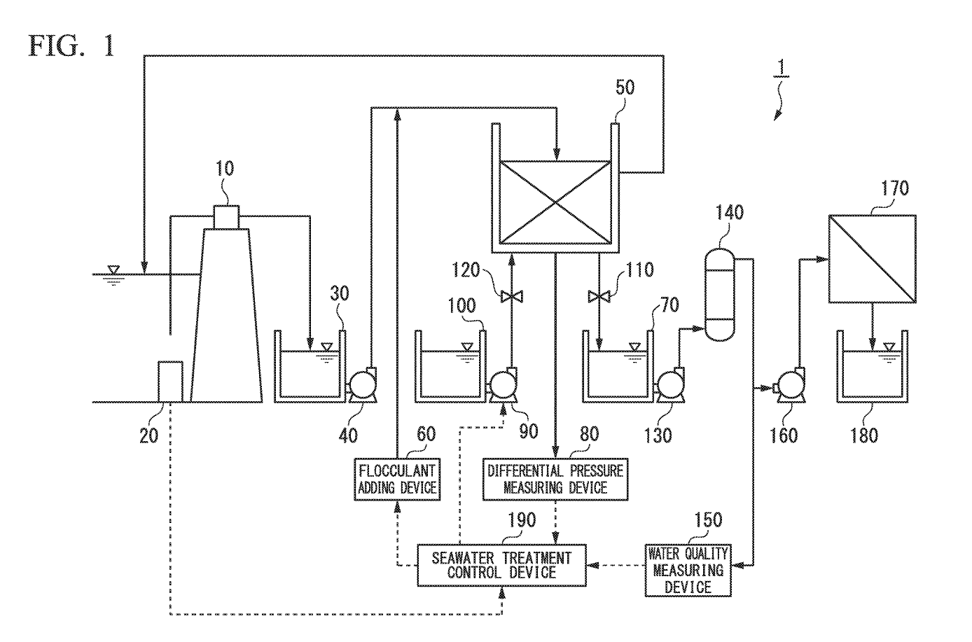

FIG. 1 is a schematic diagram showing a constitution of a seawater treatment system 1 related to a first embodiment. Note that, in FIG. 1, solid arrows indicate distributing pipes and dashed arrows indicate communication lines.

The seawater treatment system 1 is a system configured to manufacture freshwater from seawater. The seawater treatment system 1 includes a water intake device 10, a tide level gauge 20, a first water storage tank 30, a first pump 40, a sand filtering device 50, a flocculant adding device 60, a second water storage tank 70, a differential pressure measuring device 80, a backwash pump 90, a backwash water tank 100, a first valve 110, a second valve 120, a second pump 130, a filter device 140, a water quality measuring device 150, a third pump 160, a reverse osmotic membrane 170, a third water storage tank 180, and a seawater treatment control device 190.

The water intake device 10 draws seawater from a body of water to be drawn from. The water intake device 10 stores the drawn seawater in the first water storage tank 30.

The tide level gauge 20 measures tide levels of the body of water to be drawn from. As the tide level gauge 20, for example, an ultrasonic gauge, an immersion gauge or the like can be used.

The first pump 40 sends the seawater stored in the first water storage tank 30 to the sand filtering device 50.

The sand filtering device 50 passes the seawater sent through the first pump 40 through sands spread therein and filters the seawater. The seawater filtered by the sand filtering device 50 is stored in the second water storage tank 70.

The flocculant adding device 60 adds a flocculant to the seawater sent through the first pump 40. The flocculant adding device 60 is an example of a treatment device configured to perform treatment which contributes to purification of drawn natural water.

The differential pressure measuring device 80 measures a differential pressure between a water inlet port and a water outlet port of the sand filtering device 50.

The backwash pump 90 sends water stored in the backwash water tank 100 through the water outlet port of the sand filtering device 50 and backwashes the sand filtering device 50. Note that the seawater or concentrated water discharged from the reverse osmotic membrane 170 is stored in the backwash water tank 100. Water sent to the sand filtering device 50 through the backwash pump 90 is discharged to the sea or a waste water treatment facility. The backwash pump 90 is an example of the treatment device configured to perform treatment used to contribute to purification of drawn natural water.

The first valve 110 is provided between the water outlet port of the sand filtering device 50 and a water inlet port of the second water storage tank 70. The first valve 110 is open during a normal operation of the seawater treatment system 1 and is closed during backwash treatment thereof.

The second valve 120 is provided between the water outlet port of the sand filtering device 50 and a water outlet port of the backwash pump 90. The second valve 120 is closed during a normal operation of the seawater treatment system 1 and is open during backwash treatment thereof.

The second pump 130 sends the seawater stored in the second water storage tank 70 to the filter device 140.

The filter device 140 is a filter (for example, about 10 micrometers) coarser than that of the reverse osmotic membrane 170 and filters the seawater sent through the second pump 130.

The water quality measuring device 150 measures water quality of the seawater filtered through the filter device 140. A water quality management device related to this embodiment acquires a silt density index (SDI) as an index of water quality. The SDI is acquired on the basis of a filtration time when a certain amount of water has been filtered using a 0.45 micrometer nitrocellulose blended filter paper at a constant pressure.

The third pump 160 sends the seawater filtered through the filter device 140 to the reverse osmotic membrane 170. The third pump 160 operates at higher pressure than the first pump 40 and the second pump 130.

The reverse osmotic membrane 170 filters out only water molecules in the seawater sent through the third pump 160. Freshwater filtered through the reverse osmotic membrane 170 is stored in the third water storage tank 180.

The seawater treatment control device 190 controls the flocculant adding device 60 and a backwash device on the basis of the tide levels of the body of water to be drawn from, the water quality of the seawater filtered through the filter device 140, and the differential pressure of the sand filtering device 50.

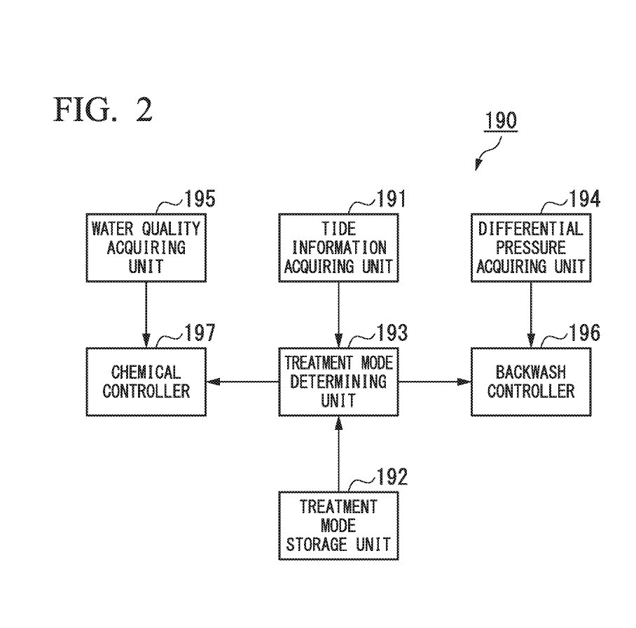

FIG. 2 is a schematic block diagram showing a software constitution of a seawater treatment control device 190 related to the first embodiment.

The seawater treatment control device 190 includes a tide information acquiring unit 191, a treatment mode storage unit 192, a treatment mode determining unit 193, a differential pressure acquiring unit 194, a water quality acquiring unit 195, a backwash controller 196, and a chemical controller 197.

The tide information acquiring unit 191 acquires tide levels measured by the tide level gauge 20 as tide information.

The treatment mode storage unit 192 associates tide levels of a body of water to be drawn from with treatment modes of the flocculant adding device 60 and the backwash pump 90 and stores the associations.

The treatment mode determining unit 193 determines treatment modes of the flocculant adding device 60 and the backwash pump 90 on the basis of the tide information acquired by the tide information acquiring unit 191 and the information stored in the treatment mode storage unit 192.

The differential pressure acquiring unit 194 acquires a differential pressure of the sand filtering device 50 measured by the differential pressure measuring device 80.

The water quality acquiring unit 195 acquires an SDI of seawater filtered through the filter device 140 measured by the water quality measuring device 150.

The backwash controller 196 controls an operation of the backwash pump 90 on the basis of the treatment modes determined by the treatment mode determining unit 193 and the differential pressure acquired by the differential pressure acquiring unit 194.

The chemical controller 197 controls an operation of the flocculant adding device 60 on the basis of the treatment modes determined by the treatment mode determining unit 193 and the SDI acquired by the water quality acquiring unit 195.

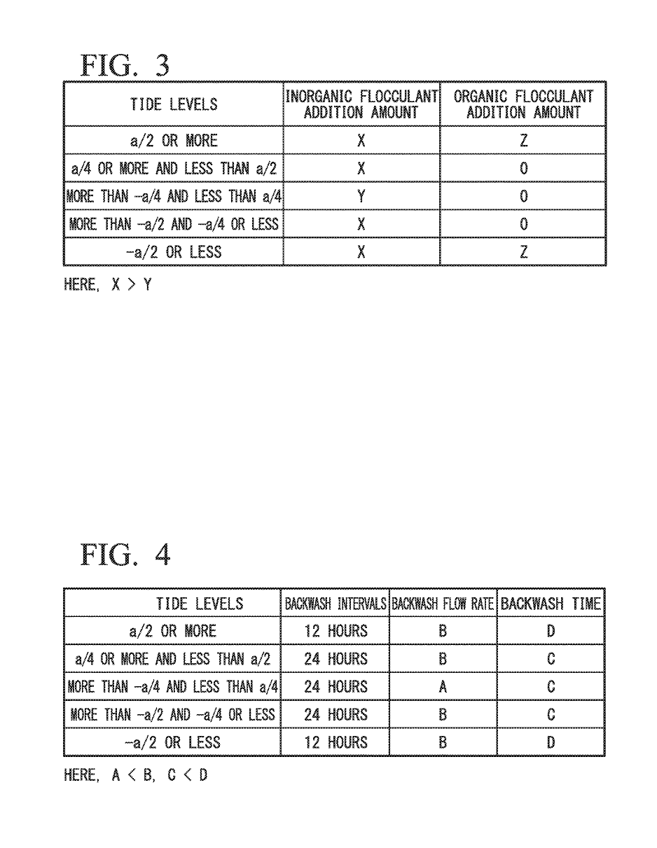

FIG. 3 is a view illustrating an example of a relationship between tide levels of a body of water to be drawn from and treatment modes of the flocculant adding device 60.

The treatment mode storage unit 192 stores an amount of addition of an inorganic flocculant and an amount of addition of a polymer flocculant in association with the tide levels of the body of water to be drawn from. Examples of the inorganic flocculant include ferric chloride and the like. Furthermore, examples of the polymer flocculant include a cationic-based polymer flocculant and the like such as a polyacrylic ester compound.

The treatment mode storage unit 192 sets a difference between a tide level at the time of high tide and a tide level at the time of low tide at half tide to a for a tide level of a body of water to be drawn from and stores an amount of deviation from an average value of the tide level at the time of high tide and the tide level at the time of low tide at half tide. In other words, a tide level being a/2 or more indicates a tide level being equal to or more than a tide level at the time of high tide at half tide.

The treatment mode storage unit 192 stores a treatment mode which is associated with a tide level of more than −a/4 and less than a/4 and in which Y milligrams/liter of an inorganic flocculant is added.

The treatment mode storage unit 192 stores a treatment mode which is associated with a tide level of a/4 or more and less than a/2 and a tide level of more than a/2 and −a/4 or less and in which X milligrams/liter of an inorganic flocculant is added. Note that X is a value larger than Y. In other words, according to this embodiment, an amount of addition of the inorganic flocculant is larger when a deviation between the average value of the tide level at the time of high tide and the tide level at the time of low tide at half tide and a measured tide level is larger.

The treatment mode storage unit 192 stores a treatment mode which is associated with a tide level of a/2 or more and a tide level of −a/2 or less and in which X milligrams/liter of an inorganic flocculent is added and Z milligrams/liter of a polymer flocculent is added. In other words, when the tide level is a tide level higher than that at the time of high tide or the tide level is a tide level that is lower than that at the time of low tide at half tide, the seawater treatment control device 190 adds a polymer flocculant in addition to an inorganic flocculant. The polymer flocculant is used for further aggregating contaminants aggregated by the inorganic flocculant.

Hereinafter, the reason why the type and amount of addition of a flocculant are different in accordance with a tide level will be described. A phenomenon in which seawater is stirred due to the ebb and flow of tides so that water masses with different temperatures and water qualities are mixed around a thermocline layer and sediment from the sea bottom is resuspended occurs. Thus, a degree of mixing of water and an amount of resuspension of sediment are different in accordance with a tide level of seawater. For this reason, an appropriate type and an amount of addition of a flocculant are specified in advance and associated with a tide level so that a delay in control with respect to a change in water quality due to the tidal cycle of the moon can be reduced.

FIG. 4 is a view illustrating an example of a relationship between tide levels of a body of water to be drawn from and treatment modes of the backwash pump 90.

The treatment mode storage unit 192 stores a treatment mode which is associated with a tide level of more than −a/4 and less than a/4 and in which a backwash interval is set to 24 hours, a backwash flow rate is set to A, and a backwash time is set to C.

The treatment mode storage unit 192 stores a treatment mode which is associated with a tide level of a/4 or more and less than a/2 and a tide level of more than −a/2 and −a/4 or less and in which a backwash interval is set to 24 hours, a backwash flow rate is set to B, and a backwash time is set to C. Note that a velocity of B is lower than that of A.

The treatment mode storage unit 192 stores a treatment mode which is associated with a tide level of a/2 or more and a tide level of −a/2 or less, a backwash interval is set to 12 hours, a backwash flow rate is set to B, and a backwash time is set to D. Note that a time of D is longer than that of C.

In other words, according to this embodiment, when a deviation between an average value of a tide level at the time of high tide and a tide level at the time of low tide at half tide and a measured tide level is larger, a backwash flow rate (a product of a backwash flow rate and a backwash time) is greater.

Hereinafter, a reason why a frequency and a flow rate of backwash are different in accordance with a tide level will be described. The inventors found that the turbidity of seawater in a period of time of spring tides is higher than the turbidity of seawater in a period of time of neap tides. It is thought that this is caused by the fact that a phenomenon in which seawater is stirred due to the ebb and flow of tides so that water masses with different temperatures and water qualities are mixed around a thermocline layer and sediment from the sea bottom is resuspended occurs and the fact that activities of marine organisms become active in a period of time of spring tides. For this reason, the frequency and the flow rate of the backwash are determined on the basis of a tide level of seawater at the time of high tide or at the time of low tide so that a delay in control with respect to a change in water quality due to tidal cycles of the moon can be reduced.

Next, an operation of the seawater treatment control device 190 related to this embodiment will be described.

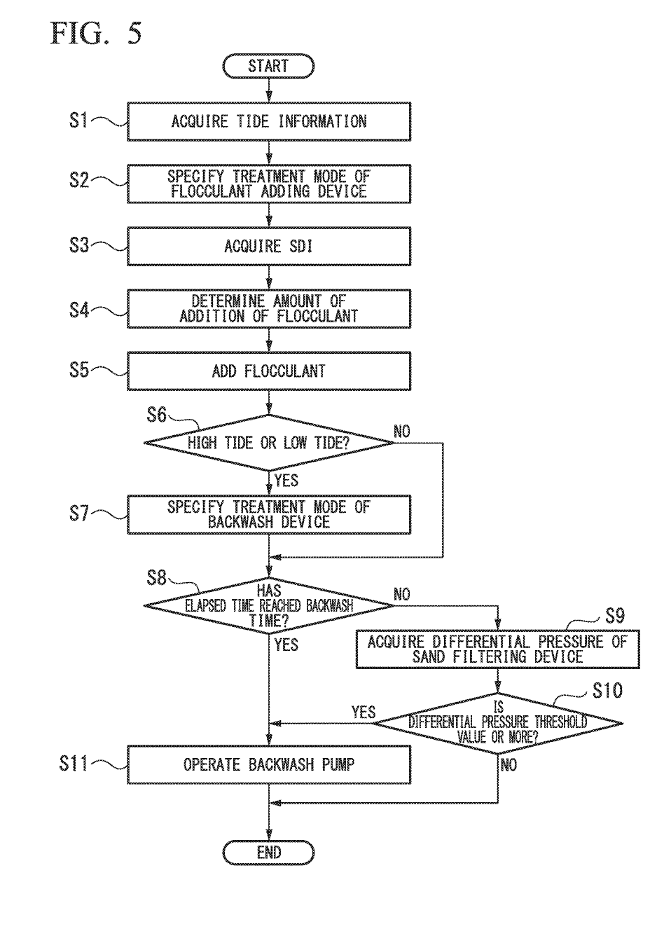

FIG. 5 is a flowchart for describing the operation of the seawater treatment control device 190 related to the first embodiment.

If the seawater treatment system 1 starts to operate, the tide information acquiring unit 191 of the seawater treatment control device 190 acquires tide information from the tide level gauge 20 (Step S1). Subsequently, the treatment mode determining unit 193 specifies a treatment mode of the flocculant adding device 60 associated with a tide level indicated by the tide information (Step S2). Subsequently, the water quality acquiring unit 195 acquires an SDI of seawater filtered through the filter device 140 from the water quality measuring device 150 (Step S3).

The chemical controller 197 determines amounts of addition of an inorganic flocculant and a polymer flocculant added to the flocculant adding device 60 on the basis of amounts of addition of an inorganic flocculant and a polymer flocculant indicated by the treatment mode determined by the treatment mode determining unit 193 and the SDI of the filtered seawater (Step S4). To be specific, the chemical controller 197 calculates an additional amount of addition of a flocculant on the basis of an SDI acquired by the water quality measuring device 150. The additional amount of addition of the flocculant has a larger value when the SDI is higher. Furthermore, the chemical controller 197 adds the additional amount of addition thereof calculated on the basis of the SDI to the amounts of addition of the inorganic flocculant and the polymer flocculant determined by the treatment mode determining unit 193 and thus the amounts of addition of the inorganic flocculant and the polymer flocculant are added to the flocculant adding device 60. Note that a chemical controller 197 related to another embodiment may calculate an addition coefficient from an SDI instead of the additional amount of addition, multiply an amount of addition determined by a treatment mode determining unit 193 by the addition coefficient, and thus determine amounts of addition of an inorganic flocculant and a polymer flocculant added to a flocculant adding device 60.

The chemical controller 197 adds the inorganic flocculant and the polymer flocculant to the flocculant adding device 60 at the determined amounts of addition (Step S5).

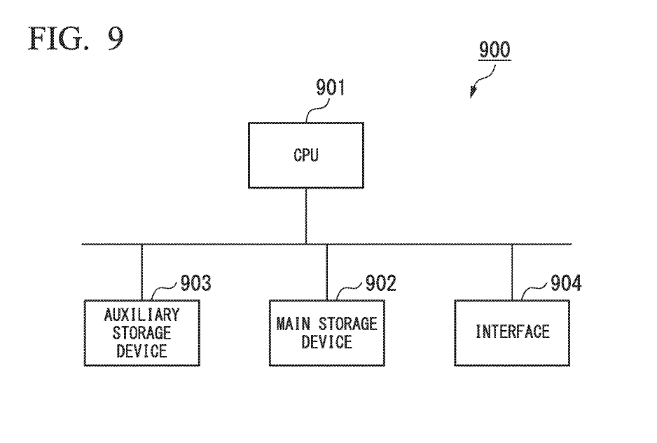

Subsequently, the treatment mode determining unit 193 determines whether a current time is a time of high tide or low tide (Step S6). The treatment mode determining unit 193 determines whether the current time is included in a pre-specified time period of high tide or low tide and thus determines whether the current time is a time of high tide or low tide. When the current time is a time of high tide or low tide (Step S6: YES), the treatment mode determining unit 193 specifies a treatment mode of the backwash pump 90 associated with a tide level indicated by the tide information (Step S7). The treatment mode determining unit 193 records the specified treatment mode on an auxiliary storage device 903 (refer to FIG. 9).

When the current time is not a time of high tide or low tide (Step S6: NO) or when the treatment mode determining unit 193 has specified a treatment mode of the backwash pump 90 in Step S7, the backwash controller 196 determines whether an elapsed time from a time at which a last backwash process was performed has reached a backwash interval recorded on the auxiliary storage device 903 (Step S8). When an elapsed time from a time at which a last backwash process was performed has not reached a backwash interval (Step S8: NO), the differential pressure acquiring unit 194 acquires a differential pressure of the sand filtering device 50 from the differential pressure measuring device 80 (Step S9). The backwash controller 196 determines whether the differential pressure acquired by the differential pressure acquiring unit 194 is a predetermined threshold value or more (Step S10). The threshold value is set for the purpose of determination of functional deterioration of the sand filtering device 50 due to accumulation of contaminants.

When the differential pressure acquired by the differential pressure acquiring unit 194 is less than a predetermined threshold value (Step S10: NO), a process of the seawater treatment control device 190 ends.

When an elapsed time from a time at which a last backwash process was performed has reached a backwash interval (Step S8: YES) or when a differential pressure acquired by the differential pressure acquiring unit 194 is a predetermined threshold value or more (Step S10: YES), the backwash controller 196 closes the first valve 110, opens the second valve 120, and then operates the backwash pump 90 at a backwash flow rate recorded on the auxiliary storage device 903 during a backwash time recorded on the auxiliary storage device 903 (Step S11). The backwash controller 196 operates the backwash pump 90 during the backwash time and then opens the first valve 110 and closes the second valve 120. Then, a process of the seawater treatment control device 190 ends.

The above-described process is repeatedly performed so that the seawater treatment control device 190 can appropriately perform treatment used to contribute to purification of seawater on the basis of a tide level of a body of water to be drawn from. Thus, the seawater treatment control device 190 can minimize a delay in control when the water quality of seawater drawn through tides rapidly changes in a short amount of time. Furthermore, the seawater treatment control device 190 related to this embodiment appropriately performs treatment used to contribute to purification of seawater on the basis of a tide level measured by the tide level gauge 20. Thus, even if an unsteady change such as a bore occurs in addition to a regular tide level change, a delay in control can be minimized.

Note that the seawater treatment control device 190 related to this embodiment performs treatment used to contribute to purification of seawater using a tide level measured by the tide level gauge 20, but the present invention is not limited thereto. For example, a seawater treatment control device 190 related to another embodiment may perform treatment used to contribute to purification of seawater using publicly-available measurement data obtained by a public institution and the like and published.

Also, the seawater treatment control device 190 related to this embodiment performs treatment used to contribute to purification of seawater on the basis of patterns of the tide levels shown in FIGS. 3 and 4, but the present invention is not limited thereto. For example, a seawater treatment control device 190 related to another embodiment may perform treatment used to contribute to purification of seawater on the basis of different patterns of tide levels in accordance with the water quality of a body of water to be drawn from.

### Second Embodiment

The seawater treatment control device 190 related to the first embodiment performs treatment used to contribute to purification of seawater on the basis of a tide level measured by the tide level gauge 20. On the other hand, a seawater treatment control device 190 related to a second embodiment performs treatment used to contribute to purification of seawater on the basis of types of tides according to an ecliptic longitude difference. The types of tides are information indicating states of tides on the basis of a positional relationship between the sun and the moon which is represented as “spring tide,” “half tide,” “neap tide,” “long tide,” and “transitional tide.”

Note that, according to definitions defined by the Japan Meteorological Agency, spring tide occurs when an ecliptic longitude difference is at 0 degrees or more and less than 36 degrees, 168 degrees or more and less than 216 degrees, or 348 degrees or more and less than 360. In other words, spring tide occurs when the number of days since a new moon is 0 days or more and less than three days, 14 days or more and less than 19 days, or 29 days or more and less than 30 days.

Note that half tide occurs when an ecliptic longitude difference is at 36 degrees or more and less than 72 degrees, 132 degrees or more and less than 168 degrees, 216 degrees or more and less than 252 degrees, or 312 degrees or more and less than 348 degrees. In other words, half tide occurs when the number of days since a new moon is three days or more and less than 7 days, 12 days or more and less than 14 days, 18 days or more and less than 22 days, or 27 days or more and less than 29 days.

Note that neap tide occurs when an ecliptic longitude difference is at 72 degrees or more and less than 108 degrees or 252 degrees or more and less than 288 degrees. In other words, neap tide occurs when the number of days since a new moon is 7 days or more and less than 10 days or 22 days or more and less than 24 days.

Note that long tide occurs when an ecliptic longitude difference is at 108 degrees or more and less than 120 degrees or 288 degrees or more and less than 300 degrees. In other words, long tide occurs when the number of days since a new moon is 10 days or more and less than 11 days or 25 days or more and less than 26 days.

Note that transitional tide occurs when an ecliptic longitude difference is at 120 degrees or more and less than 132 degrees or 300 degrees or more and less than 312 degrees. In other words, transitional tide occurs tide when the number of days since a new moon is 11 days or more and less than 12 days or 26 days or more and less than 27 days.

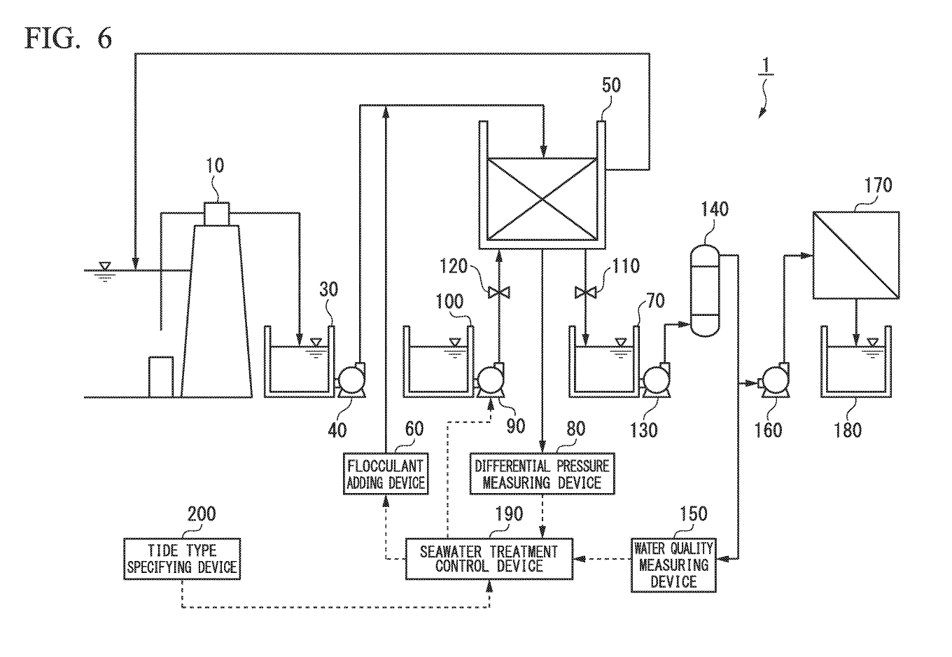

FIG. 6 is a schematic diagram showing a constitution of a seawater treatment system 1 related to the second embodiment.

The seawater treatment system 1 related to this embodiment includes a tide type specifying device 200 instead of the tide level gauge 20 of the first embodiment.

The tide type specifying device 200 specifies a type of tide on the basis of a date. Hereinafter, a method of specifying a type of tide using the tide type specifying device 200 will be described. Tide tables indicating relationships between dates and types of tides are issued by hydrographic institutions or the like in countries (in Japan, the Japan Meteorological Agency and the Japan Hydrographic Association). The tide tables include types of tides at any place calculated on the basis of daily ecliptic longitude differences. On the other hand, a relationship between ecliptic longitude differences and tide levels is different depending on a latitude and a terrain of a body of water to be drawn from. For this reason, the tide type specifying device 200 related to this embodiment specifies a current type of tide using a tide table corrected on the basis of information on a body of water to be drawn from. Examples of a method of correcting a tide table include a method of adding an offset to a date indicated by a tide table or subtracting an offset from a date indicated by a tide table on the basis of a difference between an ecliptic longitude difference of a place indicated by the tide table and an ecliptic longitude difference of a body of water to be drawn from. Furthermore, examples of another method of correcting a tide table include a method of measuring a daily change of water quality of a body of water to be drawn from and adding an offset to a date indicated by a tide table or subtracting an offset from a date indicated by a tide table so that the change coincides with a type of tide.

The seawater treatment control device 190 related to this embodiment controls a flocculant adding device 60 and a backwash device on the basis of a type of tide of a body of water to be drawn from, a water quality of seawater filtered through a filter device 140, and a differential pressure of a sand filtering device 50.

The seawater treatment control device 190 related to this embodiment and the seawater treatment control device 190 of the first embodiment differ in view of information stored in a treatment mode storage unit 192 and operations of a treatment mode determining unit 193, a chemical controller 197, and a backwash controller 196 in this embodiment.

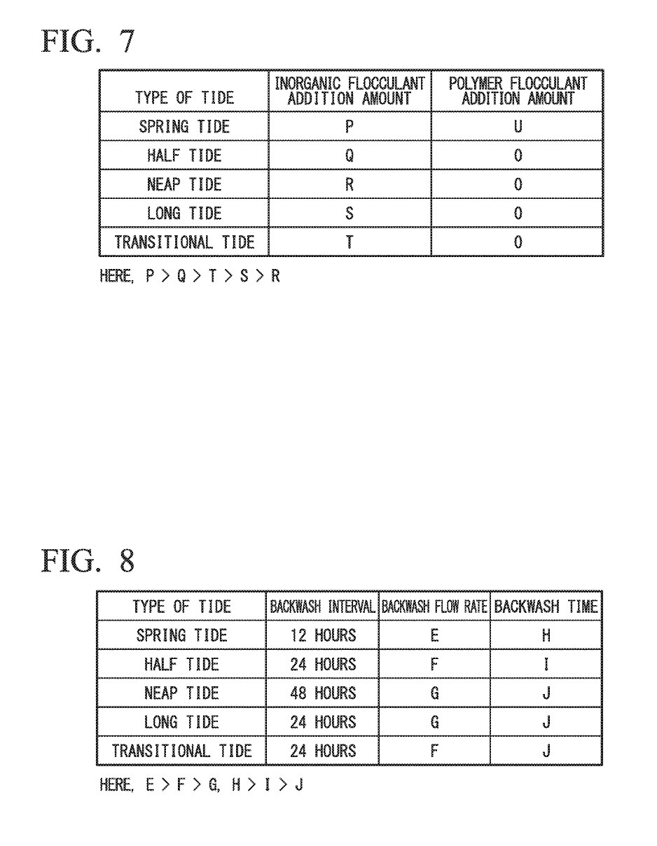

FIG. 7 is a view illustrating an example of a relationship between types of tides of a body of water to be drawn from and treatment modes of the flocculant adding device 60.

The treatment mode storage unit 192 stores an amount of addition of an inorganic flocculant and an amount of addition of a polymer flocculant in association with a type of tide of a body of water to be drawn from.

The treatment mode storage unit 192 stores a treatment mode which is associated with spring tide and in which the inorganic flocculant is added at P milligrams/liter and the polymer flocculant is added at U milligrams/liter. The treatment mode storage unit 192 stores a treatment mode which is associated with half tide and in which the inorganic flocculant is added at Q milligrams/liter. The treatment mode storage unit 192 stores a treatment mode which is associated with neap tide and in which the inorganic flocculant is added at R milligrams/liter. The treatment mode storage unit 192 stores a treatment mode which is associated with long tide and in which the inorganic flocculant is added at S milligrams/liter. The treatment mode storage unit 192 stores a treatment mode which is associated with transitional tide and in which the inorganic flocculant is added at T milligrams/liter.

Note that, in the case of an amount of addition of the inorganic flocculant, P is the largest and the amount of addition thereof decreases in the order of Q, T, S, and R. In other words, an amount of addition of a flocculant in a period of time of spring tide which has a large difference between low tides and in which there is likely to be more contaminants is the most and an amount of addition of the flocculant in a period of time of neap tide which has a small difference between low tides and in which there is likely to be hardly any contaminants is the smallest. Furthermore, an amount of addition of the flocculant in a period of time of long tide in which movement of the tide is small is smaller than an amount of addition of the flocculant in a period of time of half tide. An amount of addition of the flocculant in a period of time of transitional tide in which movement of the tide becomes active is more than an amount of addition of the flocculant in a period of time of long tide just before that.

FIG. 8 is a view illustrating an example of a relationship between types of tides of a body of water to be drawn from and treatment modes of the backwash pump 90.

The treatment mode storage unit 192 stores a treatment mode which is associated with spring tide and in which a backwash interval is set to 12 hours, a backwash flow rate is set to E, and a backwash time is set to H. The treatment mode storage unit 192 stores a treatment mode which is associated with half tide and in which a backwash interval is set to 24 hours, a backwash flow rate is set to F, and a backwash time is set to I. The treatment mode storage unit 192 stores a treatment mode which is associated with neap tide and in which a backwash interval is set to 48 hours, a backwash flow rate is set to G, and a backwash time is set to J. The treatment mode storage unit 192 stores a treatment mode which is associated with long tide and in which a backwash interval is set to 24 hours, a backwash flow rate is set to G, and a backwash time is set to J. The treatment mode storage unit 192 stores a treatment mode which is associated with transitional tide and in which a backwash interval is set to 24 hours, a backwash flow rate is set to F, and a backwash time is J.

Note that, in the case of a backwash flow rate, E is the fastest and the backwash flow rate is lower in the order of F and G. Furthermore, in the case of a backwash time, H is the longest and the backwash time is shorter in the order of I and J. In other words, a backwash flow rate in a period of time of spring tide which has a large difference between low tides and in which there is likely to be more contaminants is the highest and a backwash flow rate in a period of time of neap tide which has a small difference between low tides and in which there is likely to be hardly any contaminants is the smallest. Furthermore, a backwash flow rate in a period of time of long tide of which movement of the tide is small is smaller than a backwash flow rate in a period of time of half tide. A backwash flow rate in a period of time of transitional tide in which movement of the tide becomes active is more than a backwash flow rate in a period of time of long tide just before that.

The tide information acquiring unit 191 of the seawater treatment control device 190 related to this embodiment acquires tide information indicating the day's type of tide from the tide type specifying device 200 at a fixed time every day (for example, at midnight). Furthermore, the treatment mode determining unit 193 determines a treatment mode on the basis of the tide information. The treatment mode determining unit 193 records the determined treatment mode on an auxiliary storage device 903 (refer to FIG. 9).

The chemical controller 197 determines an amount of addition of the flocculant added to the flocculant adding device 60 on the basis of an amount of addition of the inorganic flocculant and an amount of addition of the polymer flocculant recorded on the auxiliary storage device 903 and an additional amount of addition specified on the basis of an SDI acquired by the water quality acquiring unit 195.

The backwash controller 196 operates the backwash pump 90 in accordance with a backwash flow rate and a backwash time recorded on the auxiliary storage device 903 for every backwash interval recorded on the auxiliary storage device 903. Furthermore, the backwash controller 196 operates the backwash pump 90 in accordance with the backwash flow rate and the backwash time recorded on the auxiliary storage device 903 when a differential pressure acquired by the differential pressure acquiring unit 194 is a predetermined threshold value or more.

As described above, the seawater treatment control device 190 appropriately performs treatment used to contribute to purification of seawater on the basis of a tide level of a body of water to be drawn from. Thus, the seawater treatment control device 190 can minimize a delay in control when the water quality of seawater drawn changes rapidly in a short time due to tides.

Note that the seawater treatment control device 190 related to this embodiment performs treatment used to contribute to purification of seawater on the basis of a type of tide, but the present invention is not limited thereto. For example, a seawater treatment control device 190 related to another embodiment may perform treatment used to contribute to purification of seawater on the basis of other information indicating a positional relationship between the sun and the moon such as an ecliptic longitude difference or the number of days since a new moon.

Also, the seawater treatment control device 190 related to this embodiment performs treatment used to contribute to purification of seawater on the basis of only a type of tide, but the present invention is not limited thereto. For example, a seawater treatment control device 190 related to another embodiment may perform treatment used to contribute to purification of seawater in consideration of a treatment mode specified on the basis of a type of tide and a treatment mode specified on the basis of a tide level of a body of water to be drawn from.

Although some embodiments have been described in detail above with reference to the drawings, specific constitutions thereof are not limited to those described above and various changes in design or the like are possible.

For example, cases in which the seawater treatment control device 190 controls addition of the flocculant and backwash of the sand filtering device 50 has been described in the above-described embodiments, but the present invention is not limited thereto. For example, a seawater treatment control device 190 related to another embodiment may control only addition of the flocculant and may control only backwash of the sand filtering device 50. Furthermore, the backwash pump 90 related to the above-described embodiments has the sand filtering device 50 as a backwash target, but the present invention is not limited thereto. For example, a backwash pump 90 related to another embodiment may use another filtering device such as a filtering device using a material such as a fibrous material and a sintered body other than gravel as a filter medium or a reverse osmotic membrane 170 as a backwash target.

Also, the treatment device configured such that the flocculant adding device 60 and the backwash pump 90 perform treatment used to contribute to purification of drawn natural water has been exemplified in the above-described embodiments, but the present invention is not limited thereto. Examples of a treatment device configured to perform treatment used to contribute to the purification of the drawn natural water also include a device configured to maintain the filter device 140, the reverse osmotic membrane 170, or the like. Furthermore, when a seawater treatment system includes a pressurized floating device configured to generate bubbles in water and float contaminants in the water using the buoyancy of the bubbles, a device configured to maintain the corresponding pressurized floating device is also a treatment device configured to perform treatment used to contribute to purification of the natural water.

Also, the seawater treatment control device 190 has been described as an example of a natural water treatment control apparatus in the above-described embodiment, but the present invention is not limited thereto. For example, in another embodiment, a natural water treatment control apparatus may be applied to a control device configured to control a natural water treatment system configured to purify natural water drawn from a lake or marsh.

FIG. 9 is a schematic block diagram showing a constitution of a computer 900 related to at least one embodiment.

The computer 900 includes a central processing unit (CPU) 901, a main storage device 902, an auxiliary storage device 903, and an interface 904.

The seawater treatment control device 190 described above is mounted in the computer 900. Furthermore, the above-described operations of the processing units are stored in the auxiliary storage device 903 in a form of programs. The CPU 901 reads the programs from the auxiliary storage device 903, develops the programs in the main storage device 902, and executes the processes in accordance with the programs.

Note that, in at least one embodiment, the auxiliary storage device 903 is an example of a non-transitory tangible medium. Other examples of the non-transitory tangible medium include a magnetic disk, a magnetic optical disc, a compact disc-read only memory (CD-ROM), a digital versatile disc (DVD)-ROM, a semiconductor memory, and the like. Furthermore, such a program is distributed to the computer 900 through a communication circuit, and the computer 900 receiving the distribution may develop the corresponding program in the main storage device 902 and execute the above-described process.

Also, the corresponding program may be for the purpose of realizing a part of the above-described functions. In addition, the corresponding program may be a so-called differential file (differential program) configured to be realized through combination of the above-described functions with another program stored in the auxiliary storage device 903 in advance.

### INDUSTRIAL APPLICABILITY

According to at least one aspect of the present invention, a natural water treatment control apparatus determines a treatment mode of a treatment device on the basis of information associated with tides of a body of water from which natural water is drawn. Thus, the natural water treatment control apparatus can operate the treatment device in a treatment mode according to an amount of contaminants in the natural water.

### REFERENCE SIGNS LIST

1 Seawater treatment system
10 Water intake device
20 Tide level gauge
30 First water storage tank
40 First pump
50 Sand filtering device
60 Flocculant adding device
70 Second water storage tank
80 Differential pressure measuring device
90 Backwash pump
100 Backwash water tank
110 First valve
120 Second valve
130 Second pump
140 Filter device
150 Water quality measuring device
160 Third pump
170 Reverse osmotic membrane
180 Third water storage tank
190 Seawater treatment control device
191 Tide information acquiring unit
192 Treatment mode storage unit
193 Treatment mode determining unit
194 Differential pressure acquiring unit
195 Water quality acquiring unit
196 Backwash controller
197 Chemical controller
200 Tide type specifying device
900 Computer
901 CPU
902 Main storage device
903 Auxiliary storage device
904 Interface

1. A natural water treatment control apparatus which controls a treatment device configured to perform treatment used to contribute to purification of drawn natural water, the natural water treatment control apparatus comprising:
a tide information acquiring unit configured to acquire tide information serving as information associated with tides of a body of water from which the natural water is drawn; and
a treatment mode determining unit configured to determine a treatment mode of the treatment device on the basis of the tide information.

2. The natural water treatment control apparatus according to claim 1, wherein the treatment device is a backwash device of a filtering device configured to filter the drawn natural water, and
the treatment mode determining unit determines at least one of a frequency and an amount of water for backwash of the filtering device using the treatment device on the basis of the tide information.

3. The natural water treatment control apparatus according to claim 1, wherein the treatment device is a flocculant adding device configured to add a flocculant to the drawn natural water, and
the treatment mode determining unit determines at least one of an amount of addition and a type of the flocculant of the treatment device on the basis of the tide information.

4. The natural water treatment control apparatus according to claim 1, wherein the tide information includes a tide level of a natural water drawing source, and
the treatment mode determining unit determines a treatment mode of the treatment device on the basis of a difference between an average value of tide levels at the time of high tide and at the time of low tide of the water drawing source and tide levels indicated by the tide information.

5. The natural water treatment control apparatus according to claim 1, wherein the tide information includes information indicating a positional relationship between the sun and the moon.

6. A natural water treatment system comprising:
a treatment device configured to perform treatment used to contribute to purification of drawn natural water; and
the natural water treatment control apparatus according to claim 1.

7. A natural water treatment control method for controlling a treatment device configured to perform treatment used to contribute to purification of drawn natural water, the natural water treatment control method comprising:
a step of acquiring tide information serving as information associated with tides of a body of water from which the natural water is drawn; and
a step of determining a treatment mode of the treatment device on the basis of the tide information.

8. A program causing a computer, stored in a non-transitory computer readable recording medium to function as:
a tide information acquiring unit configured to acquire tide information serving as information associated with tides of a body of water from which natural water is drawn; and
a treatment mode determining unit configured to determine a treatment mode of a treatment device configured to perform treatment used to contribute to purification of the drawn natural water on the basis of the tide information.
